(19) United States
(12) Patent Application Publication
(10) Pub. No.: US 2004/0142203 A1
(43) Pub. Date: Jul. 22, 2004

(54) Hydrogen storage medium

(76) Inventor: Christopher P. Woolley, Sebastapol, CA (US)

Correspondence Address: EDWARD S. SHERMAN, 5698 EAGLE ROCK CT., SANTA ROSA, CA, 95409, US

(21) Appl. No.: 10/752,128

(22) Filed: Jan. 6, 2004

Related U.S. Application Data
(60) Provisional application No. 60/438,489, filed on Jan. 7, 2003.

(51) Int. Cl. B32B 15/04; B32B 15/00

(52) U.S. Cl. 428/615; 428/457

(57) ABSTRACT

The vapor deposition of metal, metal alloy, metallic compound as a thin film onto a continuous web provides a metal hydride based hydrogen storage medium, including a component for fuel cells. After or before such a single or multilayer thin film is used as or converted to metal hydride, the web is formed into the active component in a hydrogen gas storage vessel or the or an electrode layer and support for a battery or fuel cell.

### CROSS REFERENCE TO RELATED APPLICATIONS

The present application claims priority to provisional application having serial No. 60/438,489 filed on Jan. 7, 2003 which is incorporated herein by reference

### BACKGROUND OF THE INVENTION

This invention relates to a hydrogen storage medium, fuel cell medium and a method of forming the same.

The need to replace fossil fuel has become more apparent in the last few years. Hydrogen has stood out as a very good replacement. Hydrogen is a renewable fuel and can be a non-polluting fuel as well. The biggest hurdle, is storing enough hydrogen to give a hydrogen car the same range as a gasoline car. The storage of much larger amounts of hydrogen in smaller and safer ways will also be needed to develop the infrastructure for fueling hydrogen cars. Metal hydrides offer the most reasonable approach to this problem. A metal hydride alloy is a metal alloy that absorbs and desorbs hydrogen. Some of these alloys are Mg, MgNi, FeTi, and others.

Several problems with metal hydrides that remain unsolved are ease of manufacturing, increased storage, and the reduction of cost. In past art there are several methods for manufacturing metal hydride alloys such as;

(1) Grinding these alloys into small particles ranging from 30 microns to ¼ of an inch.

(2) Making the alloys into flakes as described in U.S. Pat. No. 6,193,929 (issued Feb. 27, 2001).

(3) Sputtering onto wafers, disks or plates as mentioned in U.S. Pat. No. 4,431,561 (issued Feb. 14, 1984), U.S. Pat. No. 6,238,819 (issued May 29, 2001), U.S. Pat. No. 6,328,821 (issued Dec. 11, 2001), U.S. Pat. No. 6,337,146 (issued Jan. 8, 2002), U.S. Pat. No. 6,471,795 (issued Oct. 29, 2002) and U.S. Pat. No. 6,478,844 (issued Nov. 12, 2002) among others.

U.S. Pat. No. 6,193,929 describes making the alloy particles and then physically bonding them to a support medium like mesh, grid, matte, foil, foam or plate by the use of compaction and/or then sintering. The hydride materials are put into a container. To activate the hydride material all gases are pumped out of the container and the container and the hydride are heated to break the oxide layer on the hydride material. Then the container is pressurized with hydrogen. The actual temperatures, pressures and length of time vary widely depending on the hydride alloy used. This process is repeated several times.

As the metal hydride particles absorb hydrogen they expand and break into smaller particles. As the particles get smaller they hold more hydrogen but it takes longer to charge and discharge because the space between the particles gets smaller and the paths through the material get longer.

Accordingly, it is a first object of the invention to provide an improved method of forming a high storage capacity hydrogen medium.

It is a further objective of the invention to provide an improved method and configuration for a high capacity hydrogen storage vessel.

Accordingly, it is another object of the invention to provide an improved method of forming a fuel cell medium that converts hydrogen gas to electrical power using a metal hydride forming metal as at least one component of one electrode medium.

It is a further objective of the invention to provide an improved method and configuration for a fuel cell medium that converts hydrogen gas to electrical power.

### SUMMARY OF THE INVENTION

In one aspect the instant invention deploys a process of vapor deposition to form metal and alloys (capable of forming metal hydride type compounds) onto a continuous web as a thin film, and converting the thin film to a metal hydride.

In a further aspect of the invention the flexible web having a metal, metal alloy, metal compound in the form of a single or multilayer thin film is used as or converted to metal hydride wherein the web is formed into the active component in a hydrogen gas storage vessel or the or an electrode layer and support for a battery or fuel cell.

In yet another aspect the instant invention provides for the vapor deposition of metal hydride forming compositions, including alloys, onto a continuous flexible web substrate and avoids or minimizes the reaction of oxygen with the metallic materials therein.

In another aspect of the invention the formation of the continuous flexible web substrate having a metal hydride coating as a thin film layer provides a convenient means to form a compact, efficient and high-capacity hydrogen storage vessel, as other aspects of the invention include method and configuration for inserting multiple layers of the continuous flexible web within the pressure vessel.

More specifically, the metal hydride thin film disposed on a flexible web material provides both a high surface area of the active metal hydride and enables the effective use of the high surface area in a hydrogen storage vessel. The flexible web can be folded or wrapped in layers while leaving a gas permeable gap between each layer so that hydrogen gas is readily transported from substantially all of the high surface area thin film.

In a further aspect the instant invention allows the manufacturing of an improved hydrogen storage material, in fewer steps then the past art.

Alternatively, the flexible web can be utilized within or as part of a fuel cell as a hydrogen storage plate, or in combination with a portion of the proton exchange membrane.

The above and other objects, effects, features, and advantages of the present invention will become more apparent from the following description of the embodiments thereof taken in conjunction with the accompanying drawings.

### BRIEF DESCRIPTION OF FIGURES

The various features and advantages of the present invention may be more readily understood with reference to the following detailed description taken in conjunction with the accompanying drawings, wherein like reference numerals designate like structural elements, and in which:

FIG. 1 is an elevation illustrating an exemplary coating apparatus for use in one aspect of the process of the instant invention

FIG. 2A is a perspective view illustrating an exemplary roll of web material, with FIG. 2B showing an expanded or magnified cross sectionview of a selected portion of FIG. 2A to illustrate a first embodiment of a coating design.

FIG. 3A is a perspective view illustrating the web material of FIG. 2 when formed in the hydrogen storage medium for a hydrogen storage vessel. FIG. 2B is an expanded or magnified view of a selected portion of FIG. 3A

FIG. 4A is a schematic diagram of a cross-section through a prior art hydrogen storage medium that utilizes metal hydride forming particulate.

FIG. 4A is a schematic diagram of a cross-section through a hydrogen storage medium that utilizes metal hydride deposited on a continuous web of material.

FIG. 5 is a sectional view of one embodiment of a hydrogen storage vessel or container

Reference numerals in selected drawings:

(1) Web

(2) Take up shaft

(3) Outer housing of take up container

(8) Coating on one side of the web

(9) Coating on the opposite side of the web

(10) Coated web

(20) Idler roller attached to outer housing

(22) Idler roller with load cells

(25) Chilled roller

(40) Target cathodes that deposit the metals on the web.

(50) The vacuum deposition roll to roll coater.

(60) Storage container wall

(62) Storage container flange

(63) Storage container end

(64) Storage container end with gas port

(66) Storage container end seal

(70) Gas line

(71) Gas valve

(72) Gas valve handle

(74) End supports

(76) Gas passages through end supports into center passage

### DETAILED DESCRIPTION

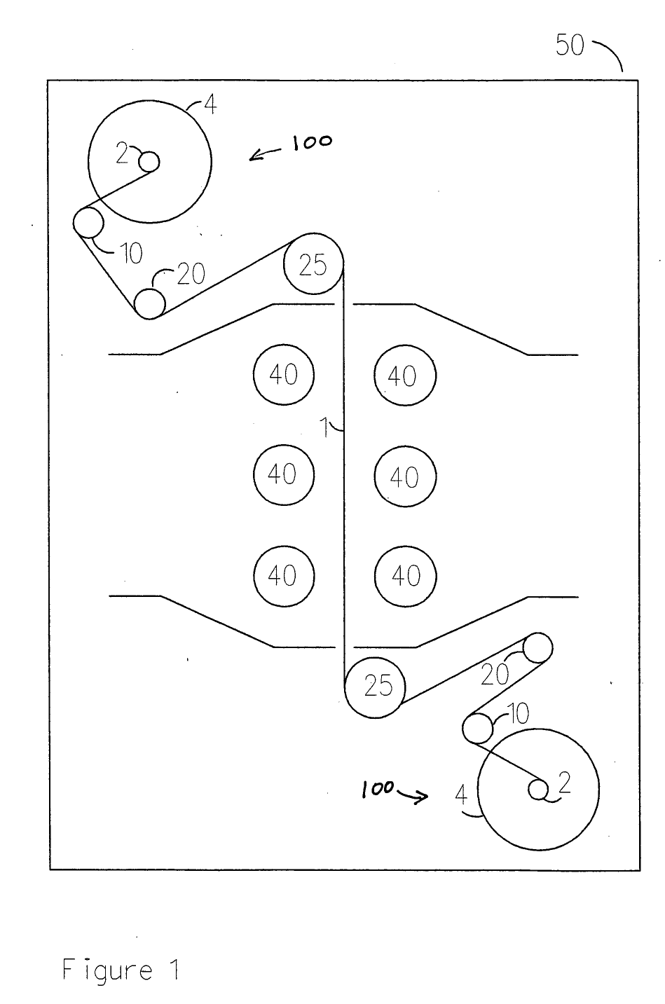

FIG. 1 illustrates an exemplary deposition system 50, a vacuum roll coater, for use in instant invention The uncoated roll of web material is loaded into the vacuum roll coater (50). The web (1) is threaded through the winding system of the coater, (Idler roller (20), idler roller with load cells (22), and chilled roller (25)). Then the web goes past the target cathodes (40), and through the rest of the winding system. Then the web is attached to the take up shaft (2).

By vacuum depositing metals, metal alloys or metal compounds, including metal hydride alloy, directly onto a flexible web the layer the hydrogen storage medium can be as thin as a few nanometers thick. This allows optimizing the layer by both thickness and structure for high storage capacity as well as durability and other desirable properties unattained alone, or in combination in the prior art. Thus a thin film structure will use the metal hydride materials more efficiently by producing much greater surface area for the same amount of metal hydride as is used in the granular form. Further, by depositing the metal hydride onto a roll of flexible web, more material can be produced at one time than in a batch type vacuum coater.

Not wishing to be bound by theory, it is believed that a further advantage on deposited a thin film on a metallic web is that the thin film material can enhance the bulk storage capacity of the web material itself. For example, in a preferred embodiment Ti metal is sputter coated on an oxide free aluminum substrate or web. While the Ti thin film may only be a fraction of a micron in thickness, it can be expected to activate or enhance the hydrogen storage capacity of a significant portion of the 10 to 200 micron thick Al web substrate. In other embodiments, the thin film optionally includes a mixture or alternating layer structure of Ti and Al. It will be recognized by those of ordinary skill in the art of metal hydride technology that numerous alternative combinations of a substrate and thin film can be expected to provide similar benefits. Alternative materials for a web substrate include steel, stainless steel, aluminum, copper, brass, magnesium, titanium and nickel, as well as polymeric substrates. It should be appreciated that the substrate need not be a hydrogen storage medium itself and can be a laminate of different materials, produced by thin or thick film deposition processes or physical bonding of discrete webs.

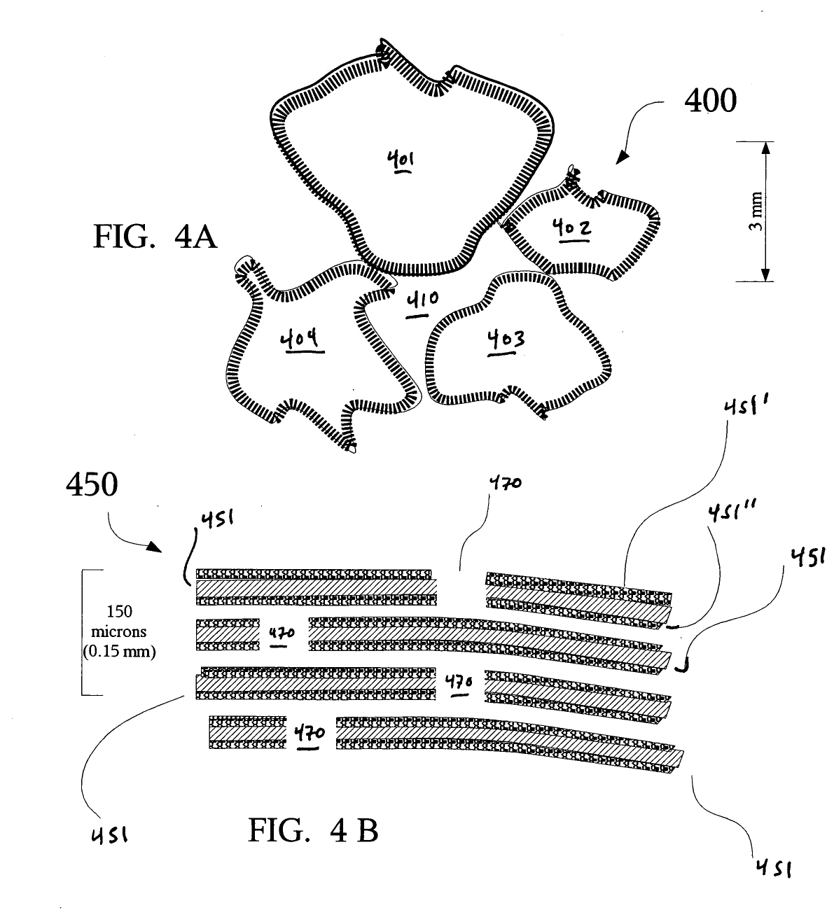

FIG. 4A represent cross sections the typical porosity and structure of metal hydride forming particles in a portion 400 of prior art device. A plurality of metal particles 401, 402, 403 and 404 have diameters of circa 3 mm, however a smaller volume, represented by a shaded outer layer on each particle, is capable of rapidly absorbing hydrogen and forming metal hydrides. Note that the irregular gaps between particles 410 provide for the transport of hydrogen in the gaseous state to the surface of the particles. In comparison, FIG. 4B schematically illustrates a cross section through a portion 450 of a device according to the teachings of the instant invention. Multiple layers of overlapping web substrate 451 have a thin film coatings (not corresponding in dimension to the illustrated scale bar) 451′ and 451″ on opposing sides. The gap 460 between each wound layer is formed by various spacers or inherent or created microtexture in the web surface, and is preferably about the same order of magnitude in thickness as the web itself, that is circa 10 to 250 microns. Further, the transport of gaseous hydrogen is enhanced by a plurality of holes or perforations in the web 470. While only the outer surface of the large particulates in FIG. 4A can be expected to effectively absorb hydrogen, the thin film and substrate illustrated in FIG. 4B present a higher surface area available for hydrogen reaction, and hence storage, more effectively utilizing the available storage volume in a vessel or container.

As the thickness, porosity and column structure of the coating can be optimized, the metal hydride should be able to absorb the hydrogen and expand without breaking into smaller particles.

A particularly preferred process for producing films of high porosity and hence surface area is disclosed in U.S. Pat. No. 5,077,258 to Phillips, et al. (Issued on Dec. 31, 1991), which is incorporated herein by reference. Phillips teaches the process of depositing a thin film material at a high pressure of inert gas to increase the films porosity. Preferably, the pressure of inert gas is such to reduce thin films density less than about 90% of the equivalent compositions bulk density. However, more preferably the thin film has a density less than about 75% of the equivalent compositions bulk density and most preferably less than about 60% of the bulk density.

It should be appreciated that it may be desirable to deposit such thin films in multiple stages to provide a lower porosity or more dense film that would better adhere to the underlying substrate, followed by a more porous or graded porosity film thereon so as to provide a higher active area for forming metal hydrides as well as permit the expansion of the porous film without substantial defoliation from the substrate.

Substrate need not be a continuous solid film, but may be partially porous or perforated to increase available surface area and provide channels for the transport of hydrogen gas when formed into a storage media. Such non-porous substrates include perforated or partially metal films or foil as well as mesh and micromesh fabrics, particularly those formed on metal wires.

Alternatively, a continuous or partially porous web may be deformed or dimpled such that a gap is left when layering or rolling the web due to the irregularity of the dimpled. Perforated metal sheet or web may be successfully deployed as an embodiment of a dimpled material to the extent that the metal is plastic deformed during the perforation process. Alternatively, partially removed perforation can also provide the same spacing or gap between layers as full perforation to the extent that a least a portion of the remaining material disturbs the regularity of the sheet or web.

Another advantage of a multistage deposition process is the ability to provide temporary or permanent barrier to oxygen to facilitate subsequent forming of the coated web into a useful storage medium without excess conversion of the metal, alloy or compound into an inert metal oxide that might require reduction back to the metallic state. By reducing the exposure to oxygen, the metal hydride materials will have much less of an oxide layer that would need to be modified. The deposited metal hydride forming thin film material is optionally over coated with a temporary or permanent barrier to oxygen that is either removed or does not adversely affect the transport or adsorption/desorption of hydrogen gas. Suitable thin film barrier films may be deposited in the same vacuum deposition process, such as are disclosed in U.S. Pat. No. 5,792,550 to Phillips, et al. (issued on Aug. 11, 1998), which is incorporated herein by reference. Other methods and compositions, which include organic barriers, are disclosed in U.S. Pat. No. 6,413,645 to Graff, et al. (Issued on Jul. 2, 2002), which is incorporated herein by reference. An organic barrier film can be at least partially removed by heating and pyrolysis of the organic material prior to reacting the thin film storage medium with an initial charge of hydrogen gas. In the case of an inorganic barrier film, preferred embodiments include 20 to 1000 nm of metal oxides, metal nitrides, metal carbides, metal oxynitrides, metal oxyborides, and combinations thereof, as well as silicon oxide, aluminum oxide, titanium oxide, indium oxide, tin oxide, indium tin oxide, tantalum oxide, zirconium oxide, niobium oxide, and combinations thereof. For example, exemplary metal nitrides include aluminum nitride, silicon nitride, boron nitride, and combinations and the like. Exemplary metal oxynitrides include aluminum oxynitride, silicon oxynitride, boron oxynitride, combinations thereof, and the like.

It should be further appreciated that such deforming, dimpling and perforating processes may be carried out after the web is coated with the metal hydride forming metal, alloy or compound, as well as after. It may be particularly advantageous to utilize a deforming, dimpling and perforating processes after a barrier layer is applied over the metal, alloy or compound, to the extend that the process defoliates or disrupts the barrier layer or alters its properties increasing the permeability of hydrogen gas their through.

Further, having the metal hydride coated on a continuous roll the thermal conductivity will be much greater than through granular particles. This makes it easier to control the temperature of the metal hydride materials. Being able to control the temperature, the hydride can be held at the temperature that absorbs or desorbs the hydrogen most effectively.

To accomplish the aforementioned processes and create the various beneficial structure described above install a roll of web material is installed in the coating apparatus of FIG. 1, for example aluminum foil or polyester film, or similar type vacuum deposition roll to roll coating equipment. The web is threaded through the winding system of the coater. One next produces a vacuum in the coating deposition chamber having a base pressure range of 1×10⁻⁵ torr to 1×10⁻⁷ torr. In preferred embodiment, the chamber is evacuated to a base pressure of about 1×10⁻⁷. After the base pressure is reached, Argon is supplied as a working gas that is ionized at the sputter targets. The flow of Argon raises the pressure to about 3×10⁻³ torr. The web is unwound from one side of the coater and pass by the targets while the targets are powered on.

Types of target material that can be used are Mg, Ti, Ni, C, Al, V, Zr, Pd, Cr, La, Mo, Y, Fe, Si and others. The targets can be a single metal or alloys or the targets can be made of different metal tiles built into one target.

Depending on the target materials deposition rate and the desired thickness of the layer, the power and line speed will vary. The web can be moved in the forward and reverse directions through the coater. By turning on and off different targets, and changing direction of the web, the order of the coating can be controlled to make different alloys.

When the coating is complete, the web will have been wound up on a take up shaft.

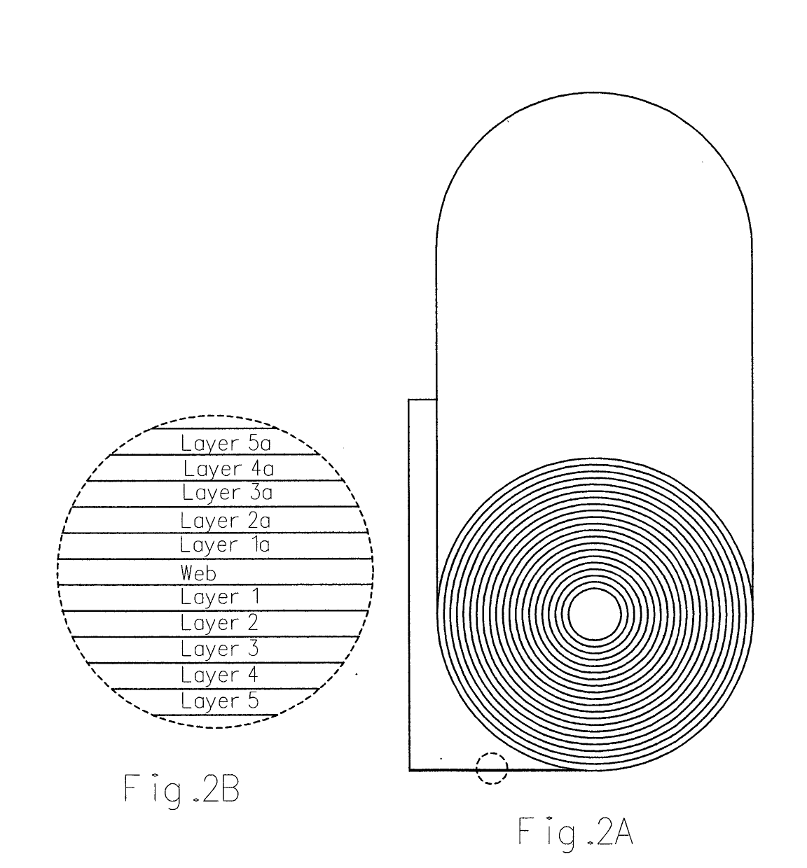

FIG. 2 shows a roll of coated web material (10) according to the instant invention. FIG. 2B is an expanded view of the highlighted region in FIG. 2A to illustrate in further detail one embodiment of a coating design. The web (1) is coated on one side by different layers (1, 2, 3, 4 and 5) these layers could be all different metals or combinations of just a few. The opposite side of the web is shown also coated with different layers (1a, 2a, 3a, 4a and 5a). These layers can be the same as the first side or different depending on the use of the material.

By vapor depositing the metal hydride alloys using such methods as sputtering, E-beam, or chemical vapor deposition, in a vacuum roll-to-roll coater it is possible to coat a thin continuous sheet (web) with the metal hydride alloys. Depositing a thin layer between 3 and 1000 nanometers (nm) thick on a web produces a large surface area of metal hydride alloy while using a small amount of metal hydride alloy material.

Vapor deposition on a continuous web provides an even coating that is well bonded to the web. Strong and uniform adhesion or bonding f the thin film coating so produced to the web improves heat transfer and provides a more optimized electrical conductivity continuously through out the web. A uniform electrical conductivity facilitates temperature control when joule or resistive heating is deployed to desorb hydrogen from the metal hydride, thus increasing either the amount of hydrogen storage capacity or the current carrying capabilities of a metal hydride thin film used as an electrode in a fuel cell.

Coating on a continuous web allows the vapor deposition process to run continuously for the length of the web. This enables the manufacturing of a large amount of metal hydride material in one vacuum cycle.

Sputtering methods are advantageous for material optimization since it is a relatively fast method. It lends itself to production of disordered materials and allows an intimate mixing of the metals at the atomic scale so that local order chemical modification can readily take place. This improves the storage capability and many other usable characteristics.

The coating machine can be designed to coat both sides of the web at one time. This allows the manufacturing of double the surface area of metal hydride alloys without increasing the amount of web material used, and the time it takes would be the same as coating just one side.

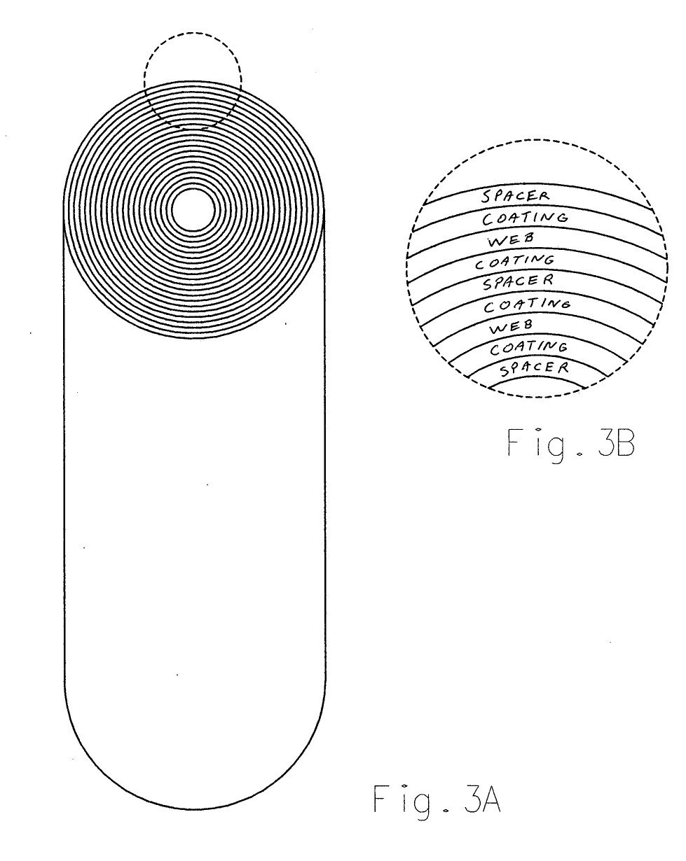

As one embodiment, by rolling the web up with a cloth like spacer material, (either woven or non-woven) or other methods of providing a gas permeable gap, between each wrap, both sides of the material are exposed. FIG. 3A shows a roll of coated web material (10) in a perspective view. The expanded view of the cross-section of material from the web in FIG. 3B shows a possible assembly design, with a spacer material (11) that provides a permeable gap, wound up between each wrap. The web (1) is coated on both sides (8 and 9). The coating designs could be the same or different. This greatly increases the exposed surface area of the hydride material making charging and discharging faster and easier. This also increases the hydrogen storage capability. With the coating process done in a vacuum with the alloys being exposed only to an Argon atmosphere, the hydride is exposed to a minimal amount of oxygen. The reduction of the oxide layer is one reason the activation process is simplified and the storage capabilities are increased.

Further, an improved hydrogen gas fuel cell is obtained by substituting a proton exchange membrane as the web material such that hydrogen can be stored within the cell and more accessible to generate electrical power. A typical proton exchange membrane placed between the anode and cathode is made of a polymer material having sulfonate functional groups contained on a fluorinated carbon backbone. Two such materials include a NAFION PEM having an equivalent weight of 1100 grams and a Dow experimental PEM (XUS-13204.20) having an equivalent weight of 800. NAFION is a sulfonic acid membrane sold by E. I. Dupont Company. Such materials and their application are more fully described in U.S. Pat. Nos. 6,167,721; 5,768,906; 5,746,064 and 5,336,570, which are incorporated herein by reference. Further, the coated proton exchange membrane or a separate layer of a metal hydride coated web may be deployed as a metal hydride compensating plate to compensate for hydrogen lost during leakage fuel cell. The metal hydride compensating plate should be able to occlude hydrogen and is designed to occlude or disassociate hydrogen upon a loss of hydrogen below a predetermined level

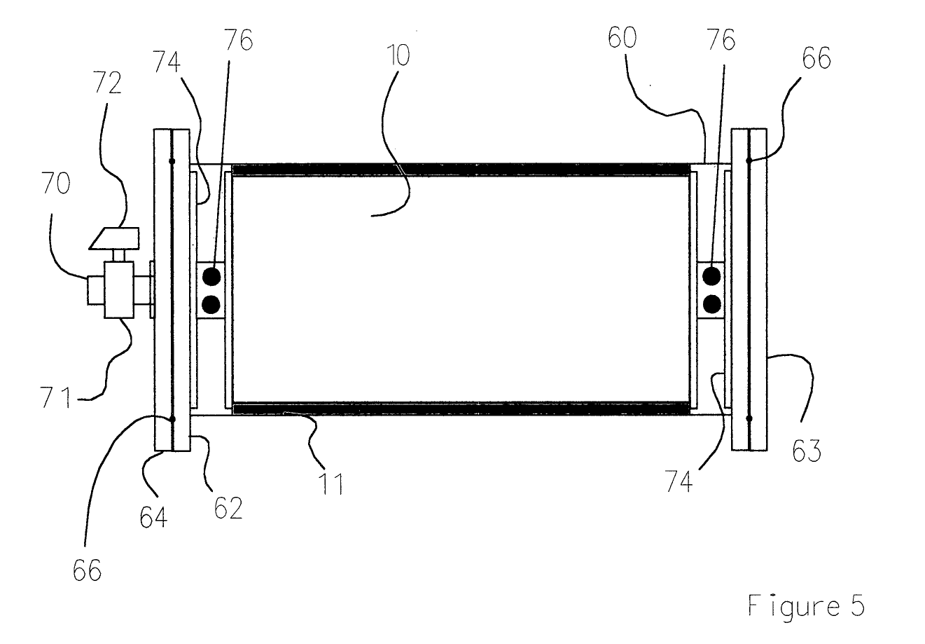

FIG. 5 shows a sectional view of a possible design for a storage container. The storage container consists of two flanges (62) on opposite ends of a wall assembly (60) this wall could be a tube. Attached to the other flange is an end piece without a port (63). Attached to one flange is an end piece with a port in it to pass gas in and out through (64). The end pieces (63 and 64) seal to the flanges (62) with a seal (66). Attached to the port in the end piece (64) is a valve (71) and attached to the valve (71) is a gas line (70) that through which the hydrogen flows in or out of the container. The valve (71) is opened or closed by turning the valve handle (72).

The roll of coated web (10) with a spacer (11) between each wrap is supported inside the container on the ends by, end supports (74). These end supports are designed to allow gas to pass out from between the wraps and into a center section through openings (76). The center section is open to the port in the end piece (64). The roll is held in the container on the sides with a spacer material (11) which provides a gas permeable gap.

Further, the roll of coated web (10) in FIG. 5 or FIG. 3 is optionally heated by resistive or joule heating by applying an electrical current to the metallic web, or a conducting layer placed in proximity thereto. Alternatively, the central core used to wind up the web can be heated directly or indirectly, wherein a combination of heat transfer from conduction and radiation results in the heating of the remainder of the web and the metal hydride film deposited thereon.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1 A metal hydride storage medium comprising:
a) a substantially continuous flexible web substrate,
b) one or more layers of a metal, metal hydride, or metal hydride-forming alloy thin film coating disposed on at least one surface of the flexible web.

2 The metal hydride storage medium of claim 1 wherein the web substrate is selected from the group consisting of steel, stainless steel, aluminum, copper, brass, magnesium, titanium and nickel.

3 The metal hydride storage medium of claim 1 wherein the web is a polymeric film.

4 The metal hydride storage medium of claim 1 wherein the web has a thickness of from about 5 microns to about 250 microns.

5 The metal hydride storage medium of claim 1 wherein the metal has a thickness of about 3 nanometers to about 1000 nanometers.

6 The metal hydride storage medium of claim 1 wherein the web is a proton exchange membrane.

7. The metal hydride storage medium of claim 1 wherein the
a) metal is selected from the group consisting of Mg, Ti, Ni, C, Al, V, Zr, Pd, Cr, La, Mo, Y, Fe, Si.

8. A metal hydride storage medium comprising:
a) a substantially continuous flexible web substrate,
b) one or more layers of a metal, metal hydride, or metal hydride-forming alloy thin film coating disposed on at least one surface of the flexible web,
c) wherein said flexible web substrate is rolled upon itself with a space between the overlapping layers thereof.

9. The metal hydride storage medium of claim 8 further comprising a gas permeable spacer disposed between the overlapping layers.

10 A metal hydride storage medium of claim 8 wherein the flexible web has a plurality of perforation there through.

11 A metal hydride storage medium of claim 8 wherein the flexible web is a fabric.

12 A metal hydride storage medium of claim 9 wherein the gas permeable spacer is a fabric.

13 A metal hydride storage medium of claim 9 wherein the web has been deformed such that irregularities in the surface thereof provide a means for spacing apart the overlapping layers of said flexible web.

14. The metal hydride storage medium of claim 1 wherein the film density as a percentage of bulk less than about 90%.

15. The metal hydride storage medium of claim 15 wherein the thin film density as a percentage of bulk less than about 75%.

16. The metal hydride storage medium of claim 1 wherein the thin film density as a percentage of bulk less than about 60%.

17. The metal hydride storage medium of claim 1 further comprising one or more diffusion barrier layers.

18. The metal hydride storage medium of claim 8 further comprising an integrated heating means.

19. The metal hydride storage medium of claim 1 further comprising web has a plurality of perforation

20. A process for forming a hydrogen storage vessel, the process comprising:
a) depositing a metal or metal alloy composition as a thin film onto a substantially continuous substrate in the form of a flexible web,
b) inserting the flexible web containing the metal or metal hydride thin film composition into a pressure vessel,
c) wherein said step of inserting includes providing a gas permeable gap between adjacent layers of the flexible web
d) sealing the pressure vessel.

21. A process according to claim 20 further comprising exposing the thin film on the web substrate to hydrogen gas to form a metal hydride or metal hydride alloy.

22. A hydrogen storage vessel, the vessel comprising:
a) a sealable pressure vessel,
b) a portal connecting the interior of the sealable pressure vessel to the exterior of the vessel,
c) a valve disposed on said portal for opening for insertion or removal of hydrogen gas from the sealable pressure vessel,
d) multiple layers of a flexible web material disposed within the sealable pressure vessel,
i) the flexible web further comprising;
(1) a metal or metal alloy thin film deposited thereon for receiving hydrogen gas to form a metal hydride storage medium, and
e) multiple layers of the flexible web being separated by a gas permeable gap.
